(19) United States
(12) Patent Application Publication
(10) Pub. No.: US 2003/0026677 A1
(43) Pub. Date: Feb. 6, 2003

(54) High-pressure process apparatus

(75) Inventors: Yoshihiko Sakashita, Takasago-shi (JP); Katsumi Watanabe, Takasago-shi (JP); Yoichi Inoue, Takasago-shi (JP); Hideshi Yamane, Takasago-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Kobe Seiko Sho (Kobe Steel, Ltd), Kobe-shi (JP)

(21) Appl. No.: 10/209,933

(22) Filed: Aug. 2, 2002

(30) Foreign Application Priority Data
Aug. 3, 2001 (JP) 2001-236858
Sep. 7, 2001 (JP) 2001-272406

(51) Int. Cl. B65G 1/00

(52) U.S. Cl. 414/217

(57) ABSTRACT

A compact high-pressure process apparatus is provided, which ensures an easy loading of a material to be process to a process chamber, as well as a high reliable operation and a high productivity. For this purpose, an opening 9 is disposed in a pressure vessel 7 including a process chamber 4, and a lid member 10 for closing the opening 9 may be pressed thereagainst by means of a press apparatus 15. In this case, a moving mechanism for moving the lid member 10 relative to the opening 9 in the direction parallel to a contact surface of the lid menber 10 and the pressure vessel 7 is further provided. The high-pressure process apparatus comprises: a high-pressure vessel 102 for storing a material, such as wafer or the like, to be processed; a press frame unit 103 for holding the axial force applied to the high-pressure vessel 102 in the axial direction by the pressure of a fluid introduced into the inside of the high-pressure vessel 102, wherein the press frame unit 103 is constituted by combining a first frame element 103a and a second frame element 103b with each other, wherein the first and second frame elements 103a and 103b are movably interposed between a pressurizing position at which the axial force of the high-pressure vessel 102 is held and a waiting position at which the frame elements are separated from each other, wherein at least one of the first and second frame elements 103a and 103b is disposed to be rotatable around the rotary axis parallel to the axis of the high-pressure vessel 102.

### BACKGROUND OF THE INVENTION

1. Field of the Invention

The present invention relates to a high-pressure process apparatus, and more specifically to a high-pressure process apparatus, which is used to carry out such a process as hot isotropic press (HIP) process, high-pressure gas oxidization, high-pressure gas nitride-formation, cleaning with liquid in a supercritical state or the like. In other word, the present invention relates to a high-temperature and high-pressure process apparatus in which solid materials to be processed are treated in a batch process, wherein each disk-shaped material, such as Si wafer, is periodically processed with a short time interval.

2. Description of the Related Art

Various process apparatuses, in which such a process is normally carried out at a high pressure, have been already proposed, for instance, in order to clean and then dry semiconductor materials by applying the supercritical technique. Japanese Patent Laid-open Publication No. 2000-340540 (referred to as a first example of the prior art), Japanese Patent Laid-open Publication No. 11-347502 (referred to as a second example of the prior art) and Japanese Patent Laid-open Publication No. 4-17333 (referred to as a third example of the prior art) can be exemplified.

In the first example of the prior art, an opening for inserting/removing such a wafer as a material to be processed in the direction parallel to the surface can be provided so as to reduce the spacing. However, since a supporting element for supporting the material to be processed is formed together with a corresponding lid in a unified structure, the material has to be completely withdrawn from the pressurized vessel in the horizontal direction. This causes the stroke of withdrawing movement to increase, thereby increasing the size of the apparatus itself. It would be particularly important to reduce the size of the apparatus from the viewpoint of using space in a clean room with high efficiency, since the construction of such a clean room is extremely expensive.

Moreover, the structure in the first example of the prior art requires a long time spending for opening/closing the opening due to an increase in the stroke, and therefore reduces the productivity. In addition, particles are generated with a higher probability and the material to be processed is contaminated by dust or the like in the environment, because the material must be held for a long time after withdrawn from the chamber.

Moreover, it is preferable that the material to be processed is rotated in the process chamber in order to obtain a high uniformity and productivity. In such a structural arrangement, however, it is substantially impossible to provide a mechanism of rotating the material to be processed because the member for supporting the material is combined with the lid to form a unified structure.

In the second example of the prior art, a lid member capable of opening/closing an opening for introducing a substrate is provide in the inside of a cylindrical main body, and the lid member is operated in the main body by a hinge, so that it is necessary to provide a space for operating the hinge. This also causes a problem of particle generation in the process apparatus and an increase in the size thereof.

In the third case of the prior art, the implementation of a mechanism for operating a lid member in a process chamber is also required, thereby causing the same problem as in the second case of the prior art, i.e., the problem of particle generation in the process apparatus and an increase in the size thereof.

### SUMMARY OF THE INVENTION

Accordingly, it is the object of the present invention to provide a high-pressure process apparatus, which ensures to insert/remove a material to be processed with ease into a process chamber and to provide a high operational stability, productivity and easy maintenance, and which apparatus is compact in the size and has a reduced space necessary for installation.

To achieve the above-mentioned object, the present invention provides the following technical means for a high-pressure process apparatus including a process chamber to which a material to be processed may be inserted:

In accordance with an aspect of the invention, a high-pressure process apparatus comprising: a pressure vessel having both a process chamber for processing a material to be processed therein and an opening for inserting/removing the material into/from the process chamber; a lid member for opening/closing the opening; a press apparatus for pressing the lid member against the pressure vessel such that the opening is closed by the lid member, and the press apparatus is designed such that the lid member is separated from the pressure vessel when the press force applied by the press apparatus is released; and a mechanism for moving the lid member relative to the opening in the direction parallel to the contact surface of the lid member and the pressure vessel.

The above structural arrangement enables the opening to securely be closed by the lid element, and the material to be easily inserted into the opening, along with a reduced installation space.

In the above structural arrangement, a guide may be disposed so as to separate the lid member from the pressure vessel when the press force applied by the press apparatus is released. In this case, it is possible to dispose a base unit, which can be moved by the mechanism for moving and the lid member and the press apparatus are connected to the base plate via the guide.

In the above structural arrangement, the lid member and the press apparatus may be constituted as a unified structure such that they are movable in the vertical direction.

Furthermore, the press apparatus can comprise a cylinder and a piston.

In the above structural arrangement, the lid member and the press apparatus may be arranged such that the pressure vessel is interposed therebetween, and such that the lid member and the press apparatus are mounted onto a frame structure.

In the above structural arrangement, it is possible that the lid member and/or the press apparatus has hook-shaped projections and an approximately ring-shaped frame is disposed so as to surround these projections. In this case, the frame may be fixed to the pressure vessel, and the lid member is movable in the frame structure of the frame. Moreover, the lid member may be constituted such that it is separated from the pressure vessel and the frame when the press force applied by the press apparatus is released.

Furthermore, the present invention is realized by a high-pressure process apparatus comprising: a pressure vessel having both a process chamber for processing a material to be processed therein and an opening for inserting/removing the material into/from the process chamber; a lid member located in the process chamber for opening/closing the opening; and a mechanism disposed outside of the pressure vessel for opening/closing the opening by a liner movement of the lid member. In this case, the contact surface of the inner surface of the pressure vessel and the facing surface of the lid member may be constituted such that they are inclined relative to the direction of the movement of the lid member for opening/closing the opening.

An appropriate convey means for inserting/removing the material to be processed into/from the process chamber via the opening can be allocated to the high-pressure process apparatus according to the invention. In this case, said convey means is disposed in a core chamber, around which a plurality of high-pressure process apparatuses each including a high pressure process vessel can be disposed in the radial direction.

In the high-pressure process apparatus according to the invention, it is possible that means for regulating the temperature in the inside of the process chamber, means for rotating the material to be processed in the process chamber and means for stirring the fluid in the process chamber can be allocated to the high-pressure process apparatus.

In accordance with another aspect of the invention, a high-pressure process apparatus comprising: a high-pressure vessel in which a material to be processed is stored; a press frame apparatus for supporting the high-pressure vessel against the axial force applied to the high-pressure vessel in its axial direction by the pressure of a fluid introduced into the inside of the high-pressure vessel, the press frame apparatus comprising a first frame element and a second frame element; wherein the first and second frame elements are disposed such that they are movable between a press position where the press frame supports the high-pressure vessel against the axial force and a waiting position where the first and second frame elements are separated from each other, wherein at least one of the first and second frame elements is disposed such that it is rotatable around a rotary axis parallel to the axis of the high-pressure vessel.

In the above structural arrangement, the frame elements are rotatably disposed, so that the frame elements provide no hindrance in the maintenance, thereby allowing an easy access to the high-pressure vessel to be obtained.

When, moreover, a base unit is disposed in a space between the first and second frame elements in the press position for supporting the high-pressure vessel, a compact high-pressure process apparatus can be realized.

Moreover, it is preferable that the high-pressure vessel is constituted by a upper vessel main body having a lower opening and a lower lid for closing the lower opening, and further the lower lid is used as a material locating part for placing the material to be processed, and the lower lid is designed such that it is movable in the vertical direction to insert/remove the material to be processed into/from the high-pressure vessel.

Moreover, it is preferable that a lift unit is disposed in a space between the first and second frame elements in the press position for moving up and down the lower lid. This structural arrangement also provides a compact high-pressure process apparatus.

When the first and second frame elements have a first contact part where they are contact with said high-pressure vessel at one end of the axis thereof and a second contact part they are contact with the high-pressure vessel at the other end of the axis thereof, and further when a space between the first and second contact parts is used as a convey passage for conveying the material to be processed in the case of the material being inserted/removed into/from the high-pressure vessel, it is possible to convey the material irrespective of the frame elements, thereby enabling a compact high-pressure process apparatus to be realized.

Moreover, it is preferable to maintain a high clean condition if the high-pressure vessel and the press frame unit are disposed in a housing.

In the high-pressure process system according to the invention, it is preferable that a handling apparatus for conveying the material to be processed is disposed in the vicinity of the high-pressure process apparatuses.

In another embodiment, it is preferable to provide an easy and reliable maintenance if the high-pressure process system is equipped with a handling apparatus for conveying the material and a plurality of high-pressure process apparatuses disposed around the handling apparatus wherein each high-pressure process apparatus has an opening for maintenance on the side opposite to the handling apparatus.

### BRIEF DESCRIPTION OF THE DRAWINGS

FIG. 1 is a plan view of a first embodiment according to the invention.

FIG. 2 is a side view of the first embodiment according to the invention together with partial longitudinal sectional view.

FIG. 3 is a plan view of a second embodiment according to the invention.

FIG. 4 is a front view of the second embodiment according to the invention.

FIG. 5 is a sectional view of the second embodiment according to the invention.

FIG. 6 is a plan view of a third embodiment according to the invention along with a partial sectional view during the press process.

FIG. 7 is a front view of the third embodiment according to the invention.

FIG. 8 is a longitudinal sectional view of the third embodiment according to the invention.

FIG. 9 is a plan view of the third embodiment according to the invention along with a partial sectional view thereof before the press process.

FIG. 10 is a front view of the third embodiment according to the invention.

FIG. 11 is a longitudinal sectional view of the third embodiment according to the invention.

FIG. 12 is a sectional view of a pressure vessel in the state of deformation for the third embodiment according to the invention.

FIG. 13 is a sectional view of the pressure chamber in the state of deformation for the third embodiment according to the invention.

FIG. 14 is an enlarged sectional view of a fourth embodiment according to the invention during the press process.

FIG. 15 is an enlarged sectional view of the fourth embodiment according to the invention after the press process.

FIG. 16 is a sectional view of the fourth embodiment according to the invention in the state of deformation during the press process.

FIG. 17 is a sectional view of the fourth embodiment according to the invention in the state of deformation after the press process.

FIG. 18 is a plan view of a system to which a high-pressure process apparatus according to the present invention is effectively applied.

FIG. 19 is a sectional view schematically showing convey means (robot) used in a high-pressure process apparatus according to the invention.

FIG. 20a is a plan view of the fifth embodiment of a high-pressure process apparatus when a material to be processed is inserted.

FIG. 20b is a sectional view of the fifth embodiment of the high-pressure process apparatus when the material to be processed is inserted.

FIG. 21a is a plan view of the fifth embodiment of the high-pressure process apparatus when the material is pressed.

FIG. 21b is a sectional view of the fifth embodiment of the high-pressure process apparatus when the material is pressed.

FIG. 22a is a plan view of the fifth embodiment of the high-pressure process apparatus in the maintenance state.

FIG. 22b is a sectional view of the fifth embodiment of the high-pressure process apparatus in the state of maintenance.

FIG. 23 is a plan view of a high-pressure process apparatus in a sixth embodiment.

### DESCRIPTION OF THE PREFERRED EMBODIMENTS

Referring now to the drawings, various aspects of the present invention will be described.

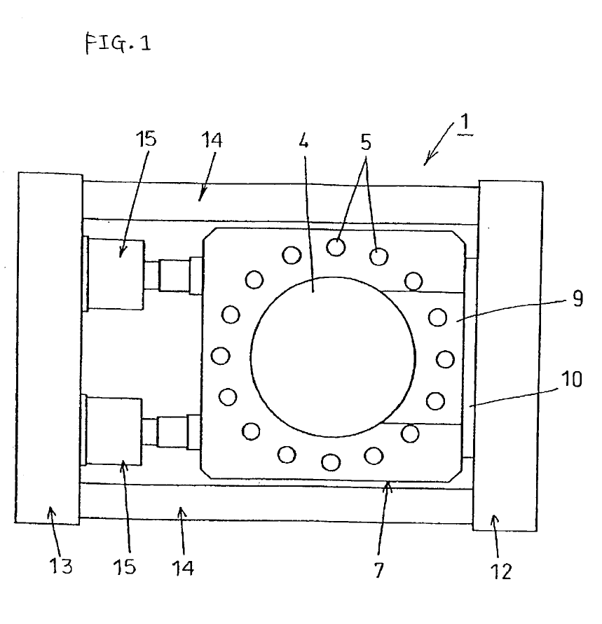

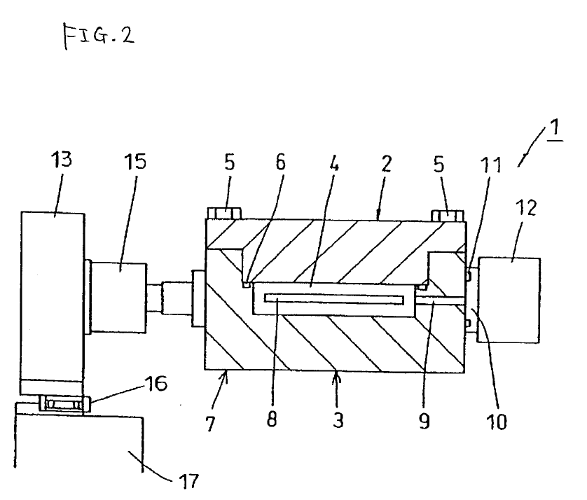

FIGS. 1 and 2 show a first embodiment of the present invention. A high-pressure process apparatus 1 in the first embodiment has therein a process chamber 4, which is constituted by an upper main body 2 (a lid in a possible case) and a lower main body 3 by engaging face parts of both main bodies with each other (coupling with counter lock). The upper and lower main bodies 2, 3 of the chamber are fixed by bolts 5 and the face parts are sealed by a flat seal 6 interposed therebetween, so that a pressure vessel 7 having the process chamber 4 inside thereof can be formed.

In another arrangement, the pressure vessel 7 can be formed as a unified structure. Alternately, the bolts 5 can be replaced with well-known fixing means (e.g., screws, bayonet joints or the like).

The pressure vessel 7 is equipped with an opening 9 for inserting/removing a material 8 to be processed into/from the process chamber 4. In the embodiment shown in FIGS. 1 and 2, the material 8 to be processed may be inserted substantially in the horizontal direction. The insertion direction is not restricted to the horizontal one. For instance, a vertical direction or an inclined direction can also be used. Since the material 8 to be processed is normally a disk-shaped material, such as a semiconductor substrate, the opening 9 should be formed in the form of a very thin slit such that it permits inserting the material 8 to be processed into the process chamber 4 in the direction parallel to the surface of the material.

A lid member 10 for opening/closing the opening 9 is disposed outside of the pressure vessel 7 and a seal (high-pressure seal) 11 is interposed between the face surface of the lid member 10 and that of the pressure vessel 7. The seal 11 prevents a process medium (for example, supercritical fluid of CO₂ or the like) from leaking out from the opening (a hole for inserting/removing the material) 9. For this purpose, a groove for the seal is formed either on the face surface of the pressure vessel 7 or that of the lid member 10. Alternately, such a groove can be formed on both face surfaces of the pressure vessel 7 and the lid member 10. The seal 11 can be set in the groove for the seal, and a seal having lips, O ring or the like can be employed as the seal.

The lid member 10 can be mounted (fixed) to a first platen 12, or in another embodiment, the lid member 10 can be formed together with the first platen 12 in a unified structure by combining the steps of both elements with each other. A second platen 13 is positioned in such a way that it faces the first platen 12 by interposing the pressure vessel 7 between the platens 12 and 13. The first and second platens 12, 13 are thus arranged in the front and rear parts of the pressure vessel 7, respectively, and connected to each other via columns 14 so as to form a frame structure in plan view.

Press apparatuses 15 are interposed between the second platen 13 and the pressure vessel 7. Since the second platen 13 is connected via columns 14 to the first platen 12 onto which the lid member 10 is mounted, the extension of the press apparatuses 15 produces a press force against the press vessel 7 such that the opening 9 is closed. The pressure vessel 7 is interposed between the lid member 10 and the pressure apparatuses 15 in order to press the lid member 10 against the pressure vessel 7 in such a way that the opening 9 is closed.

The press apparatus 15 can be constituted by a hydraulic cylinder, a screw-moving element or the like. In the case, the screw-moving element is formed by a screw which can be rotated by a motor or the like in the reciprocating manner. The press apparatus 15 is fixed neither to the surface of the second platen 13 nor to the surface of the pressure vessel 7 (however, the press apparatus can be fixed to one of them).

The second platen (rack for the press apparatus) 13 is connected to a base unit 17 via a guide 16. The guide 16 can be constituted either by a set of a rail and bushes slidably moving on the rail or by a set of a rail and wheels (rollers) rotatably moving on the rail.

The guide 16 serves to guide the lid member 10 and the press apparatus 15 via the second platen 13, columns 14 and the first platen 12 in the direction approximately parallel to the surface of the material 8 inserted in the pressure vessel 7, i.e., in the direction perpendicular to the contact surface of both the lid member 10 and the pressure vessel 7.

The movement in the direction parallel to the surface of the material 8 inserted in the pressure vessel 7 (hereinafter referred to as the surface direction) is achieved by a constriction movement of the press apparatus 15. The stroke of movement in this case is determined by the distance between the contact position (i.e., position at which the opening 9 is closed) and the position at which the lid member 10 is removed, and is realized solely by physically separating the lid member 10 from the pressure vessel 7, thereby allowing a short stroke to be used, for instance, 0.5 mm or so, and 10 mm at longest. The movement along the guide 15 is in the same magnitude as in the above-mentioned stroke.

Thus, the release of the press applied by the press apparatus 15 causes the lid member 10 to separate from the pressure vessel 7. Such a short stroke of movement in the surface direction (i.e., the direction parallel to the surface of the material 8 inserted in the pressure vessel 7) ensures to provide a reduction in the installation space and, at the same time, to provide a reduction in both the operation time and the amount of particles generated.

The base unit 17 is installed to be movable in the direction (the vertical direction in the embodiment) approximately perpendicular to the above-mentioned surface direction (the horizontal direction in the case of this embodiment). Since the second platen 13 is connected to the base unit 17 via the guide 16, the movement of the base unit 17 allows both the lid member 10 and the press apparatus 15 to move in the direction approximately perpendicular to the surface direction, i.e., in the direction parallel to the contact surface of both the lid member 10 and the pressure vessel 7.

As described above, in the state of the lid member 10 being separated from the pressure vessel 7 (in the state of the press apparatus 15 being released), the base unit 17 can be moved upwards or downwards, in the case of this embodiment, by cylinders, screws or the like, so that it arrives at a waiting position where the material 8 to be processed may be inserted/removed to/from the opening 9.

The release of the press by the press apparatus 15 causes the lid member 10 and the pressure vessel 7 to be separated from each other, and therefore there is no need of using such a special driving mechanism as a motor, a cylinder or the like so as to move the lid member 10 away from the pressure vessel 7. In other word, in order to move the lid member 10 to the waiting position, only a two-step operation, i.e., the release of the press force applied by the press apparatus 15 and the movement of the base unit 17 in the direction approximately perpendicular to the surface direction, is needed, thereby enabling the number of the driving mechanisms and the number of operation steps to be reduced.

In the embodiment shown in FIGS. 1 and 2, the press apparatus 15 is designed to press the lid member 10 in such a way that the opening 9 is closed, so that the press apparatus 15 may be disposed at a front or rear part of the pressure vessel 7 or at a upper or lower part thereof.

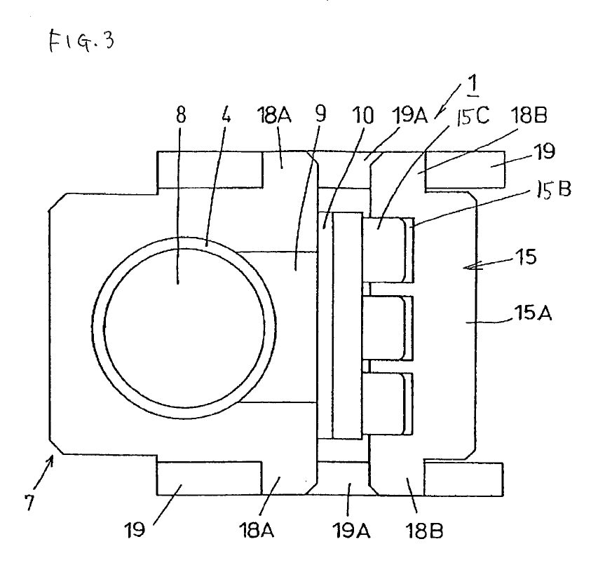

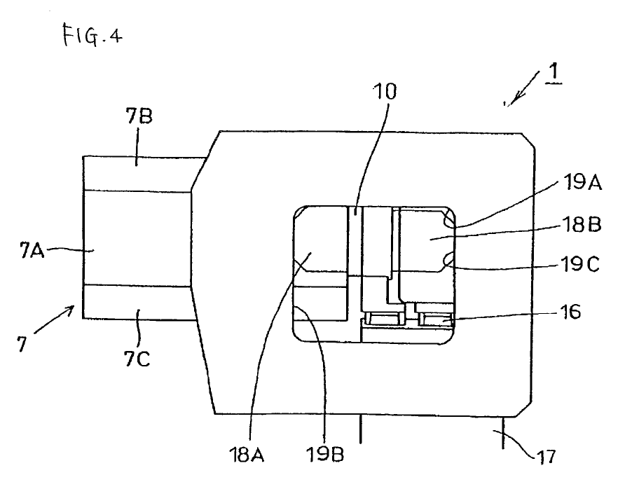

FIGS. 3 to 5 show a second embodiment of a high-pressure process apparatus 1 according to the invention. The structure and function thereof are fundamentally the same as those in the first embodiment, so that the same reference numerals are attached to the same functional elements.

The high-pressure process apparatus 1 according to the invention comprises a pressure vessel 7 having an opening 9 for inserting/removing a material 8 to be processed into/from a process chamber 4, a lid member 10 for opening/closing the opening 9, and a press apparatus 15 for pressing the lid member 10 against the pressure vessel 7 such that the opening 9 is closed by the lid member 10, whereby the lid member 10 and the press apparatus 15 are disposed to be movable both in the surface direction and in the direction perpendicular to the surface direction.

In the following, differences between the first and second embodiments will be described, referring to the drawings of FIGS. 3 to 5.

The pressure vessel 7 has the process chamber 4 in its inside, which chamber is formed by fixing upper and lower lids 7B, 7C to a vessel main body 7Awith the aid of bolt 5. In this case, flat seals 6 are interposed between the contact area of the vessel main body 7A and those of the upper and lower lids 7B, 7C. The opening 9 for inserting/removing the material 8 to be processed into/from the process chamber 4 in the horizontal direction parallel to the surface direction is formed in the vessel main body 7A.

Regarding the pressure vessel 7, a unified structure similar to that in the first embodiment can be employed, and if a separated structure as shown is employed, elements other than bolts can be used as fixing means. Furthermore, regarding the opening 9, a vertical slit or inclined slit can also be used.

The lid member 10 for closing the opening 9 can be disposed outside of the vessel main body 7A, and a seal 11 is interposed between the contact surface of the lid member 10 and that of the vessel main body 7A above and below the opening 9.

The press apparatus 15 for pressing the lid member 10 against the pressure vessel 7 such that the lid member 10 closes the opening 9 is designed to have a plurality of cylinder spaces 15B in the base part 15A and pistons 15C accommodated respectively in the cylinder spaces 15B. In this structural arrangement, the activation of the pistons 15C and the cylinders 15B with a hydraulic pressure renders a press force to the lid member 10, and when the press force is released (i.e., when the supply of the hydraulic pressure to the cylinder spaces 15B is stopped), the lid member 10 is separated from the pressure vessel 7.

Accordingly, the base part 15A in the press apparatus 15 is connected to the base unit 17 via guides 16 and the lid member 10 and the press apparatus 15 can be moved via the guides 16 in the surface direction (horizontal direction) and can also be moved in the direction (vertical direction) perpendicular to the surface direction by the up/down movement of the base part 17.

Hook-shaped projections 18A and 18B are formed at the front and rear parts of the pressure vessel 7 and at the front and rear parts of the press apparatus 15, respectively and an annular frame 19 is disposed so as to enclose the projections 18A, 18B, which are coupled to a coupling window 19A in the frame 19.

The frame 19 has to bear the press force applied by the press apparatus 15, thereby being allowed that the coupling windows 19A is equipped with facing parts 19B, 19C. As a result, the frame 19 can be constructed in the form of an U-shape (or an inversed U-shape).

The hook-shaped projections 18B can be arranged in the front and rear parts of the lid member 10 in the form of projections. Regarding the projection 18A, it can be fixed to the pressure vessel 7 (the unified structure of the frame 19 together with the pressure vessel 7 and the coupling window 19A being allowed).

In other words, the structural arrangement is allowed in which the lid member 10 is movable within the frame 19 (in the area of the coupling window 19A), and the material 8 to be processed can be removed (be able to be inserted/removed) in the state in which the lid member 10 is positioned (exists) in the frame 19.

Specifically, the release of the press force applied by the press apparatus 15 causes the lid member 10 to physically separate from the pressure vessel 7, and to move along the guides 16 in the surface direction. Thereafter, the lid member 10 and the press apparatus 15 are moved in the direction approximately perpendicular to the surface direction (i.e., downward) by the up/down movement of the base unit 17, thereby enabling the material 8 be inserted/removed via the opening 9 into/from the process chamber.

The downward movement of both the lid member 10 and the press apparatus 15 causes the projections 18A, 18B to be guided via the facing parts 19B, 19C. Such movements of the lid member 10 and the press apparatus 15 both in the surface direction and in the direction perpendicular thereto provide a reduction in the stroke of movement as in the first embodiment as well as in the installation space, and further reduce the number of process steps. In particular, the lid member 10 and the press apparatus 15 can be moved to the waiting position just after the press force is released (after being free from the press force), thereby enabling the number of process steps to be greatly reduced.

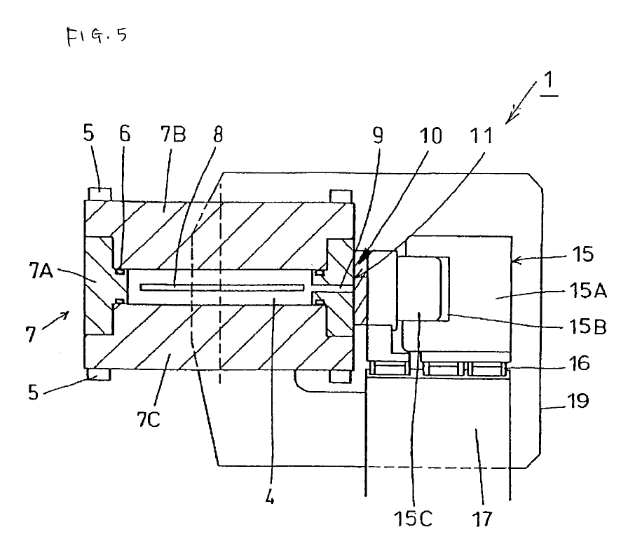

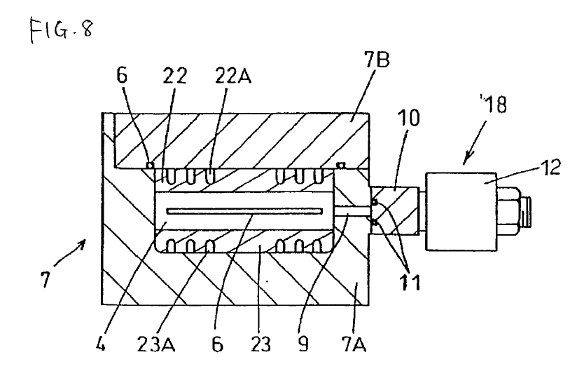

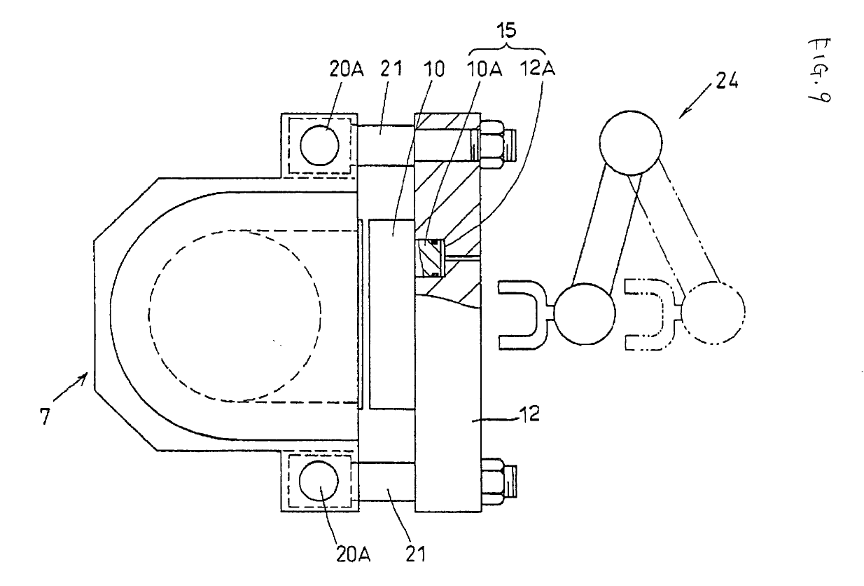

FIGS. 6 to 13 show a third embodiment of a high-pressure process apparatus 1 according to the invention. Since the structure and function thereof is basically the same as those in the first and second embodiments, the same numeral references are applied to the same functional elements.

The high-pressure process apparatus comprises a pressure vessel 7 having an opening 9 for inserting/removing a material 8 to be processed into/from a process chamber 4, a lid member 10 for opening/closing the opening 9 and a lid-driving member 18 for opening/closing the opening 9 by a linear motion of the lid member 10 wherein the lid-driving member 18 is disposed outside of the pressure vessel 7.

The lid-driving member 18 is equipped with a press apparatus 15 for pressing the lid member 10 against the pressure vessel 7 to open/close the opening 9.

In the following, the function of the high-pressure process apparatus in the third embodiment will be described, referring to the drawings of FIGS. 6 to 11. The pressure vessel 7 is constituted by a vessel main body 7A and an upper lid 7B, and then a process chamber 4 is formed in the pressure vessel by fastening them with bolts (not shown). A flat seal 6 is interposed between the facing surface of the upper lid 7B and that of the vessel main body 7A.

The opening 9 is formed in the vessel main body 7A in such a way that the material 8 to be processed can be inserted horizontally into the process chamber 4. Moreover, the opening 9 can be opened by the lid member 10 having seals 11 on the upper and lower surfaces thereof.

The lid member 10 is equipped with a plurality of pistons 10A which couple to corresponding cylinders 12A in the platen 12, so that the press apparatus 15 is formed by the pistons 10A and cylinders 12A.

Guide rods 20A are mounted on the front and rear sides of the press vessel 7 in the vertical direction, and further bearing sleeves 20 are slidably mounted onto the guide rods 20A. Connection shafts 21 are disposed in the horizontal direction at the front and rear positions of the platen 12, and fixed to the bearing sleeves 20, thereby allowing the lid-driving member 18 including both the lid member 10 and the press apparatus 15 to move up and down along the guide rods 20A by means of lift means (not shown; e.g., expandable cylinders, driving screws or the like).

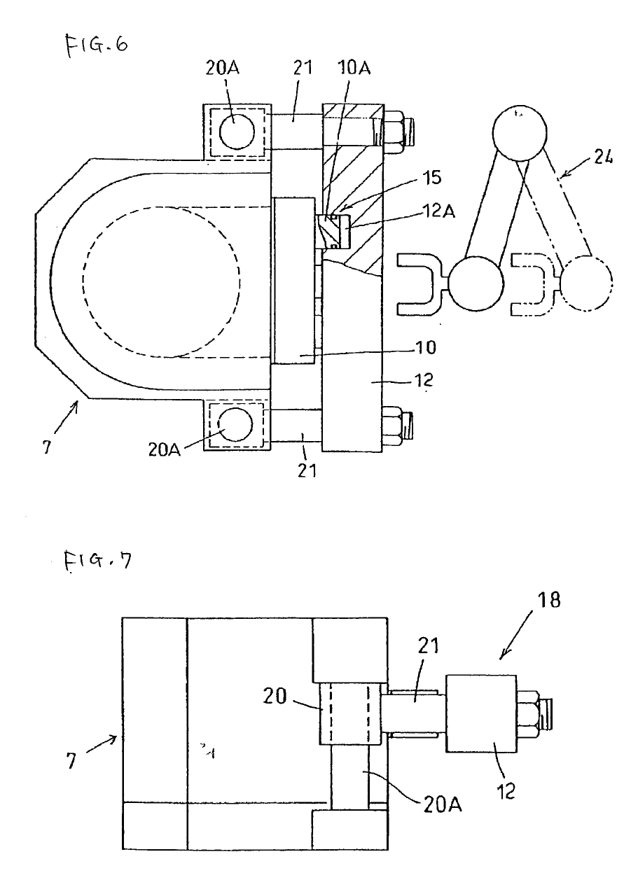

As shown in FIG. 8, temperature-regulating means 22, 23 including jackets 22A, 23A for the heating medium are mounted onto the upper and lower parts of the process chamber 4. Accordingly, the process chamber 4 can be operated at a predetermined temperature, for instance, at 40 to 100° C., by circulating a temperature-regulated heating medium supplied from heat sources in the jackets 22A, 23A.

As shown in FIG. 6, convey means 24 is disposed, in conjunction with the opening 9 (inlet for the material to be processed) formed in the pressure vessel 7. The convey means 24 picks up a material to be processed in the process chamber 4 and transfers it therefrom to a predetermined place for cassettes or the like at a high speed, passing through the opening 9. Also, the convey means 24 picks up a material 8 to be processed at a loading place of the cassettes or the like and then conveys it to the process chamber 4.

Referring now to FIG. 19, an example of the convey means 24 is shown. In this case, an expandable cylinder 24C is coupled to an output shaft 24B of a rotary motor 24A, and a fork-shaped hand part 24D is disposed at a rod of the cylinder 24C, so that the material 8 to be processed can be conveyed in the horizontal direction by a tray 24E on the hand part 24D.

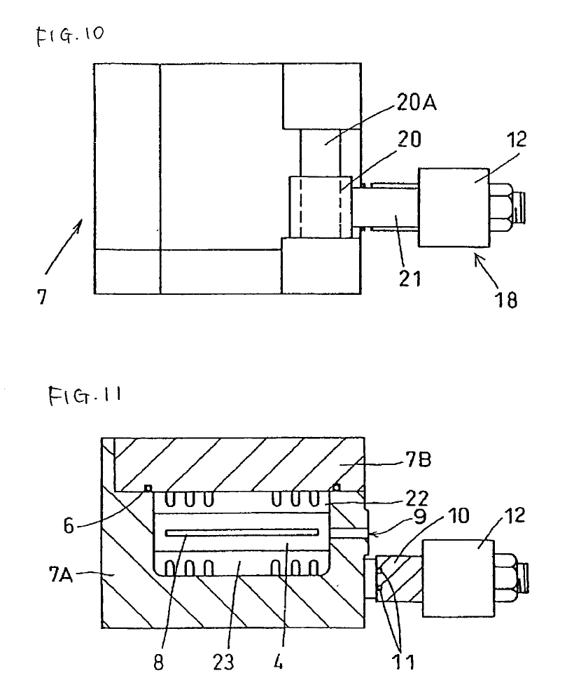

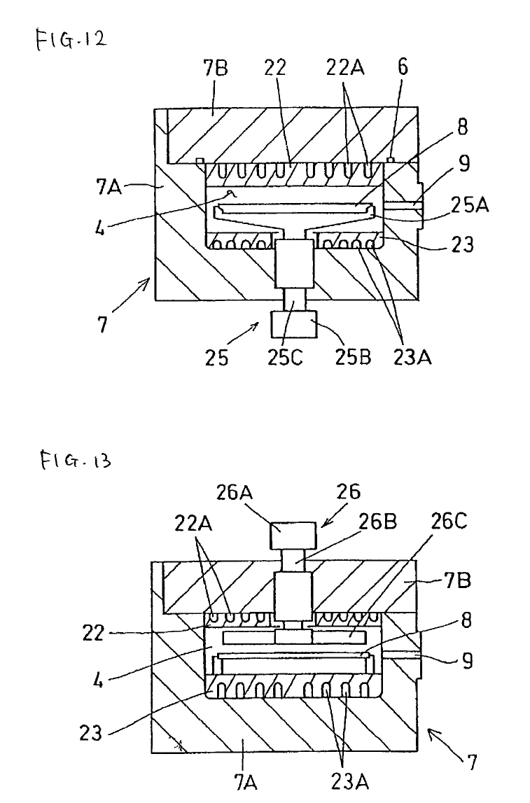

Referring to FIG. 12, it is shown that a rotary element (apparatus) 25 is used to rotate the material 8 to be processed in the process chamber 4, together with the temperature-regulating means 22, 23, by a base plate 25A onto which the material 8 is placed. The rotary element 25 is constituted by connecting the base plate 25A for the material 8 to the output shaft 25C of the rotary motor 25B.

Such an implementation of the rotary element 25 provides an appropriate rotary motion to the material 8 to be processed, and causes the speed of the pressure transfer medium relative to the surface of the material 8 to increase, thereby enabling both the homogeneity in the high-pressure process and the efficiency in the reaction to be enhanced.

FIG. 13 shows another homogenizing means wherein the process chamber 4 is equipped with a stirrer element 26. In this case, the stirrer element 26 has a stirring blade 26C on an output shaft 26B of a stirring motor 26A. Hence, the stirrer element 26 also enables both the homogeneity in the high-pressure process and the efficiency in the reaction to be enhanced.

In the third embodiment shown in FIGS. 6 to 13, the pressure vessel 7 is not movable, but stationary in the normal operation when the material 8 to be processed is inserted/removed. Moreover, the lid-driving member 18 moves up and down, and there are no obstacles at the upper and lower parts of the pressure vessel 7, so that the above-mentioned rotary element 25, and the stirrer element 26 can freely be arranged.

Alternately, a structural arrangement can be employed, wherein the pressure vessel 7 can be moved up and down and the lid-driving member 18 is stationary (but the press apparatus 15 being able to be operated).

Moreover, the convey means 24, the rotary element 25 and the stirrer element 26, as mentioned above, may also be employed in the first and second embodiments.

Moreover, the rotary element 25 can be combined with the stirrer element 26, in which case, fins or the like can be mounted on the outer surrounding of the base plate 25A of the rotary element 25, so that the operational functions of rotation and stirring can be simultaneously obtained.

In the following, the operation in the third embodiment shown in FIGS. 6 to 13 will be described.

FIGS. 9 to 11 show that a lid-driving member 18 is set at a lower position (i.e., start and standby position) and the opening 9 is set in the opened state. In this state, the convey means 24 picks up the material 8 to be processed, which is stored in a cassette, and conveys it into the process chamber 4, and then places it on the base plate 25A of the rotary element 25.

After the convey means 24 is moved to the waiting position, the lid member 10 and the press apparatus 15, which form the lid-driving member 18, are raised, and then the lid member 10 faces the opening 9. Thereafter, the contact surface of the pressure vessel around the opening 9 is pressed against the lid member 10 by actuating the press apparatus 15. In other words, the lid member 10 is pressed against the pressure vessel 7 by supplying a high-pressure fluid into the cylinder space 12A for the press apparatus 15. In this case, it is necessary that the press force is always greater than the magnitude of force, which is a product of both the maximum pressure in the process chamber 4 and the area surrounded by the seal 11 at the opening 9. In such a state, the lid member 10 is always pressed against the pressure vessel 7 during the process at a high pressure, thereby enabling a desired pressure to be always maintained in the process chamber 4.

A heating medium at a predetermined temperature flows in the jackets 22A, 23A for the heating medium at a preset flow rate, so that the upper and lower surfaces of the process chamber 4 is always maintained at a predetermined temperature. After the lid member 10 is closed, the rotary element 25 is driven and thus rotated at a predetermined revolution speed. Thereafter, a pressure transfer medium is introduced into the process chamber 4 via one or more holes (not shown) in the pressure vessel 7, thereby allowing the pressure to be increased in the process chamber. In the case of cleaning, using carbon dioxide at a supercritical state as a pressure transfer medium, the maximum pressure is normally maintained within a range of 7.5 to 20 MPa.

After arriving at a predetermined temperature and a predetermined pressure, the process chamber is maintained in the conditions mentioned above during the process. The pressure transfer medium is then exhausted from exhausting holes (not shown) so as to prevail the atmosphere pressure inside the process chamber 4. Finally, the rotation apparatus 25 is deactivated. In accordance with the type of the material 8 to be processed, either one or more additives can be included in the carbon dioxide in the supercritical state or the temperature and/or the pressure can be altered during a certain period of the process.

After the atmosphere pressure prevails in the process chamber 4, the lid member 10 is moved into the open position. This movement can be realized such that the lid member 10 is separated from the pressure vessel 7, when the supply of fluid to the press apparatus 15 is stopped. Subsequently, the lid-driving member 18 is lowered at the lower limit position and then the material 8 is removed from the process chamber 4 by activating the convey means 24. Thus, the whole process is completed after the material 8 is stored in the cassette or the like.

In accordance with the third embodiment of the invention, the structural arrangement is employed wherein the lid member for inserting the material to be processed into a high-pressure process chamber is pressed via the flat seal from the outside of the pressure vessel. As a result, the lid member can easily be opened/closed, thereby allowing to reduce the time necessary for opening/closing the lid member and to enhance the productivity. In addition, there are no slide-wearing parts for the lid member, thereby allowing generating neither dust nor fine particles. Inserting/removing a disk-like material into/from the process chamber within a plane further reduces the cross-section of the opening. This causes to provide a reduction in the press force, and thereby the apparatus itself can be formed to be compact as well as to ensure a reduction in the energy for operation.

Since, moreover, the lid supporting member (lid-driving member) can be moved upwards or downwards, and since the lid member is stopped at the waiting position departing from the pressure vessel by a few millimeters, the high-pressure process apparatus can be formed in a more compact manner, compared with the conventional apparatuses. After the high-pressure process, the material to be processed is maintained at a position, which is free from the atmosphere containing pollutants. Moreover, convey means such as a robot directly receives the material to be processed in the process chamber, and then conveys it to the cassette or the like at a high speed. These facts make it possible to provide a reduction in the pollution of the material in the course of convey as well as in the time necessary for convey, hence enhancing the productivity in the process.

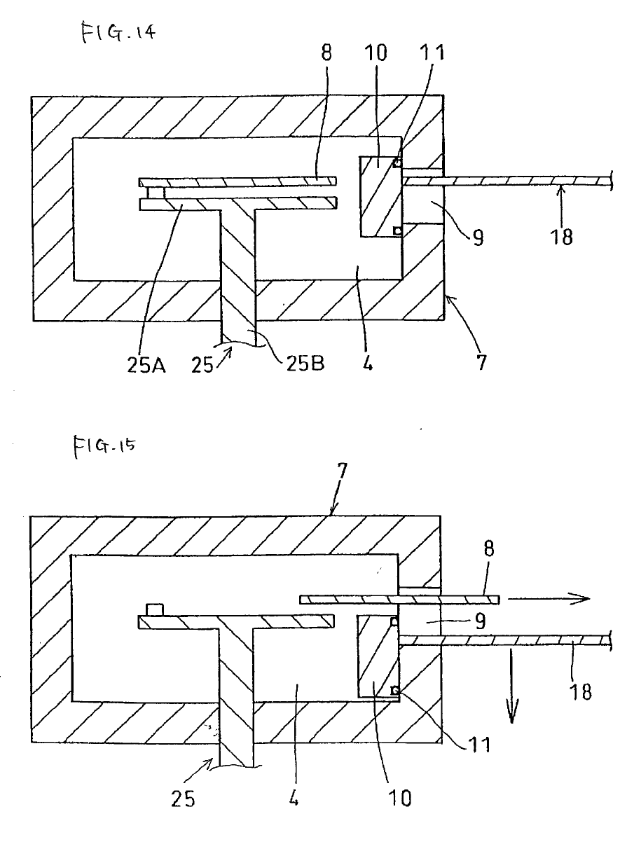

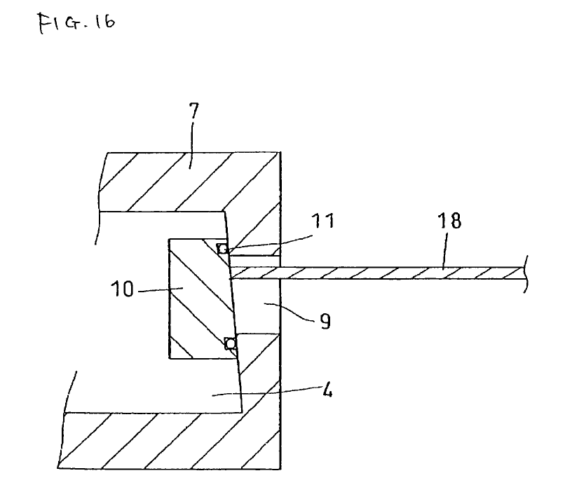

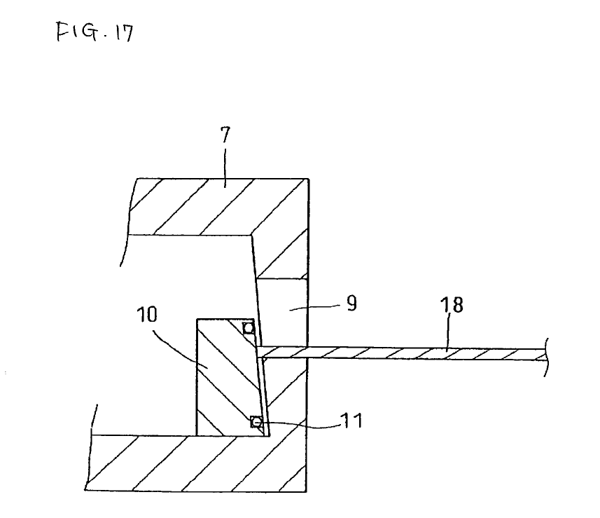

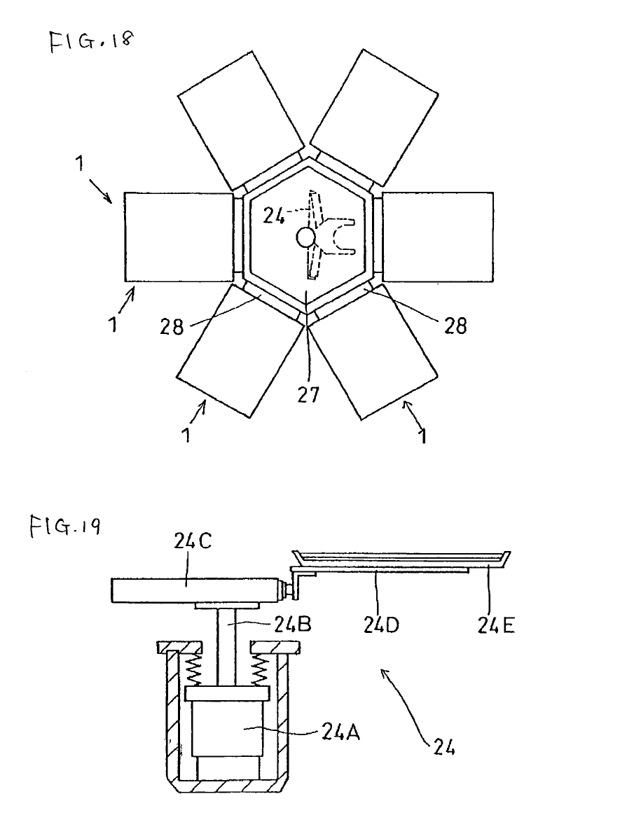

FIGS. 14 to 17 show a fourth embodiment of a high-pressure process apparatus according to the invention. In this process apparatus, an opening 9 for inserting/removing a material 8 to be processed into/from a process chamber 4 is formed inside of a pressure vessel 7. The process chamber 4 includes a base plate 25A for the material 8 to be processed and a rotary element 25 can be mounted to the base plate 25A, as similarly made in FIG. 12.

The opening 9 can be opened/closed by means of a lid member 10 disposed in the process chamber 4, and the lid member 10 includes a seal element 11 for sealing the surrounding of the opening 9. The seal element 11 is to be in contact with the inner surface of the pressure vessel 7.

The lid member 10 can be moved upwards/downwards by means of a lid-driving member 18 disposed outside of the pressure vessel 7. In this case, the lid member 10 is disposed so as to move within a distance where a wafer 8 can be moved in the vertical direction from the position at which the lid member comes into contact with the pressure vessel 7. The stroke of movement in the vertical direction should be a spacing, e.g., 10 mm or so, through which both the disk-shaped wafer 8 and a robot (convey means, see FIG. 19) for conveying the wafer 8 are able to pass.

Accordingly, the stroke of movement for the lid member 10 is small, and therefore a dead space generated in the pressure vessel 7 also becomes small. This fact makes it possible to provide a reduction in the size of the pressure vessel 7, and at the same time to reduce both the amount of gas necessary for the process and the amount of liquid necessary for cleaning. Moreover, the apparatus itself can be formed in a small size, and the space for installation also becomes small. As a result, a high-pressure process apparatus ensuring to insert/remove the material 8 into/from the process chamber 4 with ease and to provide a high operational reliability, a high productivity and an excellent ability in the maintenance.

FIGS. 16 and 17 show another embodiment of a pressure vessel according to the invention: FIG. 16 shows the pressure vessel during the process, whereas FIG. 17 shows the pressure vessel in the state in which the material is being inserted/removed into/from the process chamber.

In the case of the lid-shaped pressure vessel shown in FIGS. 14 and 15, the seal element 11 slides on the inner surface of the pressure vessel 7 so as to rub the inner surface with the contact surface of the seal element 11, when the seal element 11 moves in the vertical direction. In order to avoid such a slide motion, it is preferable that the lid member 10 is slightly moved inwards with respect to the pressure vessel 7 by the lid-driving member 18 (a distance corresponding to a sufficiently small spacing between the seal element 11 and the inner surface of the pressure vessel 7, e.g., a few millimeters), and therefore moved in the vertical direction.

In the embodiment shown in FIGS. 16 and 17, however, the lid member 10 can be moved and the material 8 (wafer 8) to be processed can be inserted/removed without any slide motion of the seal element 11 relative to the inner surface of the pressure vessel 7, even if the above-mentioned two-step movement is not employed.

As shown in FIG. 16, the contact surface of the lid member 10 and that of the pressure vessel 7 are both machined to be inclined with respect to the closing direction of the lid member 10, so that the seal element 11 does not slide on the inner surface of the pressure vessel 7, even when the lid member 10 is moved in the vertical direction, as shown in FIG. 17.

In such a state of the process at a high pressure as shown in FIG. 14 and FIG. 16, a high pressure prevails inside the process chamber 4, so that the lid member 10 is pressed onto the inner surface of the pressure vessel 7, thereby enabling the process chamber 4 to be maintained at the predetermined pressure with the aid of the seal element 11. Although the vertical movement of the lid member 10 is exemplified such that it is aligned to be in the downward direction, it is possible that the vertical movement is aligned to be in the upward direction.

Moreover, in the fourth embodiment, the process chamber can also be equipped with temperature regulating means and stirring means.

FIG. 18 shows an aspect of another useful embodiment according to the invention. In FIG. 18, such convey means 24 as shown in FIG. 19 is disposed in a core chamber 27 and a plurality of high-pressure process apparatuses 1 is arranged around the outside of the core chamber 27 and are connected therewith respectively via externally controllable gates 28 in such a manner that they are aligned to be in the radial directions.

As a high-pressure process apparatus 1 used therein, either the apparatus in anyone of the first to fourth embodiments or a system obtained by combining the apparatuses in these embodiments with each other, can be employed. In conjunction with this, it is preferable that the convey means 24 disposed in the core chamber 27 can be moved in the horizontal direction (including the linear movement and/or the rotary movement) as well as in the vertical direction.

It should be noted that the high-pressure process apparatus shown in FIG. 18 provides a high efficiency in the process at a clean environment. The high-pressure process apparatus in any of the first to fourth embodiments is useful for the batch process, but it can also be effective for the processes other than the batch process.

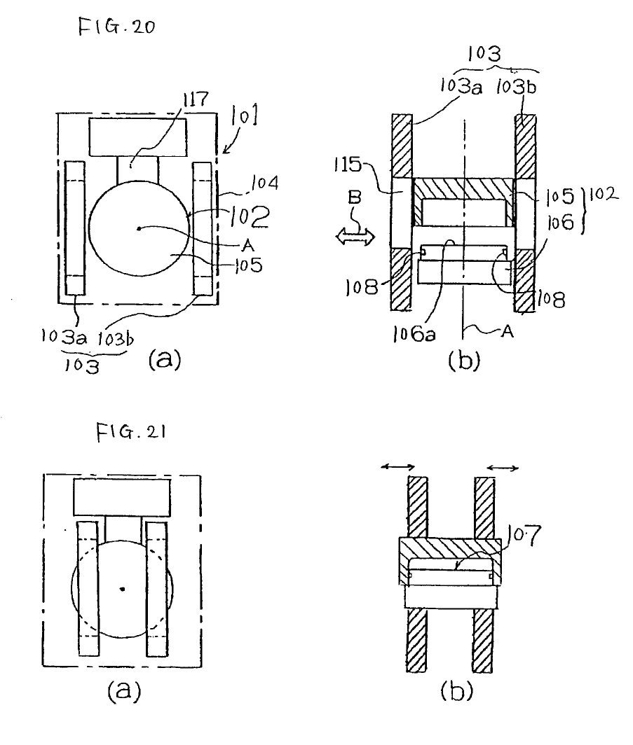

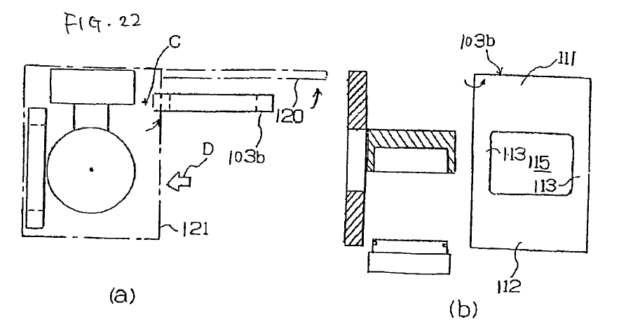

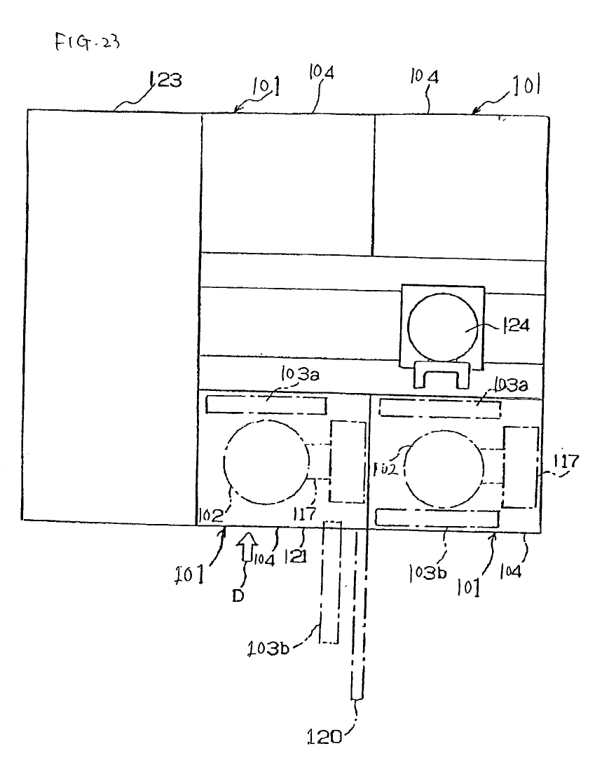

FIGS. 20 to 22 show a fifth embodiment of a high-pressure process apparatus according to the invention. FIG. 20 indicates the state in which the material to be processed is inserted or removed; FIG. 21 indicates the state of process at a high pressure; and FIG. 22 indicates the state of maintenance.

A high-pressure process apparatus 101 comprises a high-pressure vessel 102 in which a material to be processed is stored and a press frame unit 103 for supporting the axial force applied to the high-pressure vessel 102, wherein the high-pressure vessel 102 and the press frame unit 103 are disposed in a housing 104, and the environment in the housing 104 can be controlled.

The high-pressure vessel 102 has a cylindrical shape and is constituted by an upper main body 105 having an opening at its lower position and a lower lid 106 for closing a lower opening of the housing 104. The lower opening can be closed by engaging the lower lid 106 with the lower opening of the upper main body 105. In such a closed state, a process chamber (high-pressure chamber) 107 is formed to store the material to be processed inside the high-pressure vessel 102. The upper surface of the lower lid 106 serves as a material-receiving part 106a on which the material to be processed is directly or indirectly placed.

The lower lid 106 can be moved up and down in the vertical direction (in the axial direction of the high-pressure vessel 102), and has a packing element (axial seal) 108 interposed between the inner surface of the upper main body 105 and the corresponding face part of the lower lid. The packing element 108 serves as a high-pressure seal, when a high-pressure fluid is introduced in the process chamber 107.

In the embodiment shown, the upper main body 105 is formed as a unified structure. However, it can also be constituted by a high-pressure cylindrical body part having an upper opening and a lower opening and an upper lid for closing the upper opening, wherein the high-pressure cylindrical body part and the upper lid are coupled with each other via a packing element.

The press frame unit 103 serves to support the vessel 102 against the axial force, which is generated in the axial direction A of the vessel, when a high-pressure fluid is introduced in the process chamber 107. In this case, the axial force may be expressed by a product of the inside diameter of the high-pressure vessel 102 and the pressure prevailing therein.

The press frame unit 103 comprises a first frame element 103a and a second frame element 103b. As shown in FIG. 22(b), each of the first and second frame elements 103a and 103b has a first abutment 111 which is in contact with the upper part of the high-pressure vessel 102 (at one end in the axial direction thereof) and a second abutment 112 which is in contact with the lower part of the high-pressure vessel 102 (at the other end in the axial direction thereof), i.e., the lower part of the lower lid 106. The first and second abutments 111 and 112 support the high-pressure vessel 102 against the axial force, and are connected to each other via connection parts 113, 113.

In other words, each of the first and second frame elements 103a, 103b is rectangular in a plan view and has a rectangular opening 115 at its center. These rectangular openings 115 are designed such that the frame elements 103a, 103b may support the axial force and may receive accommodate high-pressure vessel 102 therein. Accordingly, the vertical size of the opening 115 is approximately the same as that of the high-pressure vessel 102, when the lower lid 106 is closed.

The first and second frame elements 103a, 103b are disposed parallel to each other. Since the press frame unit 103 is divided into the right and left frame elements 103a, 103b, a mechanism for rotating the material to be process and/or a stirring mechanism and/or a main pipe for supplying the high-pressure fluid into the high-pressure vessel can be interposed between the frame elements 103a and 103b, thereby allowing a compact high-pressure process apparatus to be realized.

In the arrangement shown in FIG. 21, a base plate 117 used for supporting the high-pressure vessel 102 is disposed in a space (spacing) between the first and second frame elements 103a and 103b. Such a structural arrangement prevents the base plate 117 from disturbing the passage for conveying the material to be processed.

The first and second frame elements 103a, 103b can be moved in the horizontal direction. When the material to be processed is inserted, as shown in FIG. 20, the first and second frame elements 103a, 103b are moved such a way that they are separated from each other (outwards in the horizontal direction) and located outside the position corresponding to the diameter of the high-pressure vessel 102, i.e. a waiting position. In this state, the lower lid 106 is withdrawn downwards from the position at which it is engaged with the vessel main body 105 by a lift unit (not shown), and then held at a predetermined position. Wafer or the like as the material to be processed is placed on the upper part of the lower lid 106, as shown in FIG. 20.

The lift unit for the lower lid 106 is positioned at the under part of the lower lid 106 or on the side part thereof, and interposed, as similar to the housing 117, between the first and second frame elements 103a, 103b in the state shown in FIG. 21. Accordingly, this arrangement provides a compact high-pressure process apparatus.

A handling apparatus (not shown) for supplying (conveying) a wafer or the like as a material to be processed is disposed in the vicinity of the high-pressure process apparatus 101, so that a high-pressure process system for processing wafers or the like is constituted by the high-pressure process apparatus 101 and the handling apparatus.

In the state in which the lower lid 106 is lowered, as shown in FIG. 20(b), an arm of the handling apparatus (not shown) receives the material to be processed on the lower lid 106 in the way passing through the opening 115 of the first frame element 103a. Moreover, a door (not shown) for mounting the material to be processed is disposed in the housing 104, allowing the material to be inserted/removed into/from the housing 104, passing through the door. In this case, the door is disposed in the vicinity of the opening 115 in the first frame element 103a.

In the case where the material to be processed is placed on the lower lid 106, the arm holding the material is moved to the lower lid 106 via a way passing through the opening of the first frame element 103a. Such a way for inserting/removing the material is indicated by arrow B in FIG. 20(b).

As can be recognized from arrow B in FIG. 20(b), the opening 115 in the first frame element 103a is used as a convey passage for conveying the material to be processed when the material is inserted/removed into/from the high-pressure vessel. The usage of the opening 115 as the convey passage makes it possible to convey the material to be processed irrespective of the first frame element 103a.

After the material to be processed is placed on the lower lid 106, the handling apparatus is removed, and the lower lid 106 is then moved upwards by the lift unit at a position at which the lower lid is coupled to the lower opening of the vessel main body. Thereafter, the first and second frame elements 103a, 103b are moved to approach each other, and then arrive at a pressurizing position (the position shown in FIG. 21), where the high-pressure vessel 102 is held by the first and second frame elements 103a, 103b, so that the high-pressure process apparatus is ready for the pressurizing operation, and therefore such a treatment at a high pressure as a supercritical treatment can be carried out.

FIGS. 22(a) and (b) show the high-pressure process apparatus 101 in the maintenance state. The housing 104 has a maintenance opening 121 in the vicinity of the second frame element 103b, in which case, the maintenance opening can be opened by means of a maintenance door 120.

The second frame element 103b is equipped with a rotary shaft (indicated by C in FIG. 22(a)), which is aligned to be in the vertical direction (parallel to the axis of the high-pressure vessel) at one end thereof, so that it can be rotated around the rotary shaft. Thus, the second frame element 103b can be rotated by 90° from the waiting position in FIG. 20.

When the maintenance door 120 is opened and then the second frame element 103b is rotated at such a position as shown in FIG. 22, the material to be processed may easily access to the high-pressure vessel 102 from the outside of the housing, as indicated by arrow D in FIG. 22, due to no presence of any hindrances. Consequently, the maintenance is easy.

Moreover, in the case of maintenance, the lower lid 106 is further lowered at a lower position (at the position of FIG. 20), compared with the normal lower position at which the material to be processed is inserted/removed, as shown in FIG. 22(b). This structural arrangement provides a sufficiently large space for maintenance work, such as packing exchange and/or cleaning.

As described above, all operations can be carried out inside such a compact housing 104 in the normal processes, whereas, in the case of maintenance, the access to the high-pressure vessel can easily achieved, after the door 120 of the housing 104 is opened and the second frame element 103b is rotated.

FIG. 23 shows a high-pressure process system in a sixth embodiment of the invention, which comprises plural high-pressure process apparatuses. The system in FIG. 23 is constituted by combining four high-pressure process apparatuses 101 with a cassette station 123 and a handling apparatus 124. A maintenance door 120 for a housing 104 of each high-pressure process apparatus 101 is arranged on one side of the aggregate of these high-pressure process apparatuses (the high-pressure process system). The passage produced at the circumference of the high-pressure process apparatuses is used as a maintenance space, so that an easy access to each high-pressure process apparatuses can be achieved, passing through the maintenance opening 121 in the maintenance direction D, after opening the corresponding maintenance door 120 and then rotating the second frame element 103b.

In this case, the first frame element 103a in each high-pressure process apparatuses 101 is disposed on the side of facing the handling apparatus 124, thereby enabling the material to be inserted/removed via a loading door of the corresponding housing 104 and an opening 115 of the first frame elements 103a.

Each maintenance opening 121 is disposed on the side opposite to the handling apparatus 124 and therefore the handling apparatus 124 provides no hindrance in the operation of the maintenance.

In conjunction with the above, it should be noted that the handling apparatus 124 is movable inside the system in such a manner that the process can be freely carried out with respect to the cassette station 123 in any of the high-pressure process apparatuses 101.

The present invention is not restricted to the above embodiments, but rather intended to cover various modifications and possible alterations within the spirit and scope of the appended claims.

What is claimed is:

1. A high-pressure process apparatus comprising:
a pressure vessel having both a process chamber for processing a material to be processed therein and an opening for inserting and removing said material into and from said process chamber;
a lid member for opening and closing said opening;
a press apparatus for pressing said lid member against said pressure vessel such that said opening is closed by said lid member, said press apparatus being designed such that said lid member is separated from said pressure vessel when the press force applied by said press apparatus is released; and
a mechanism for moving said lid member relative to said opening in the direction approximately parallel to the contact surface of said lid member and said pressure vessel.

2. The high-pressure process apparatus according to claim 1, wherein a guide is disposed so as to separate said lid member from said pressure vessel when the press force applied by said press apparatus is released.

3. The high-pressure process apparatus according to claim 2, further comprising a base plate, which is movable by said press apparatus, wherein said lid member and said press apparatus are connected to said base unit via said guide.

4. The high-pressure process apparatus according to claim 1, wherein said lid member and said press apparatus are constituted as a unified structure such that they are movable in the vertical direction.

5. The high-pressure process apparatus according to claim 1, wherein said press apparatus comprises a cylinder and a piston.

6. The high-pressure process apparatus according to claim 1, wherein said lid member and said press apparatus are arranged such that said pressure vessel is interposed therebetween, and that said lid member and said press apparatus are mounted onto a frame structure.

7. The high-pressure process apparatus according to claim 1, wherein said lid member or said press apparatus, and said pressure vessel have hook-shaped projections and an approximately ring-shaped frame is disposed so as to surround said projections.

8. The high-pressure process apparatus according to claim 7, wherein said frame is fixed to said pressure vessel, and said lid member is movable in the frame structure of said frame.

9. The high-pressure process apparatus according to claim 7, wherein said lid member is constituted such that it is separated from said pressure vessel and said frame when the press force applied by said press apparatus is released.

10. A high-pressure process apparatus comprising:
a pressure vessel having both a process chamber for processing a material to be processed therein and an opening for inserting and removing said material into and from said process chamber;
a lid member located in said process chamber for opening and closing said opening; and
a mechanism disposed outside of said pressure vessel for opening and closing said opening by a liner movement of said lid member.

11. The high-pressure process apparatus according to claim 10, wherein the contact surface of the inner surface of said pressure vessel and the facing surface of said lid member are constituted such that they are inclined relative to the direction of the movement of said lid member for opening and closing said opening.

12. A high-pressure process apparatus comprising:
a high-pressure vessel in which a material to be processed is stored;
a press frame apparatus for supporting said high-pressure vessel against the axial force applied to said high-pressure vessel in its axial direction by the pressure of a fluid introduced into the inside of said high-pressure vessel, said press frame apparatus comprising a first frame element and a second frame element;
wherein said first and second frame elements are disposed such that they are movable between a press position where said press frame supports said high-pressure vessel against the axial force and a waiting position where said first and second frame elements are separated from each other,
and wherein at least one of said first and second frame elements is disposed such that it is rotatable around a rotary axis parallel to the axis of said high-pressure vessel.

13. The high-pressure process apparatus according to claim 12, further comprising a base unit for supporting said high-pressure vessel, said base unit being disposed in a space between said first and second frame elements in said press position.

14. The high-pressure process apparatus according to claim 12, wherein said high-pressure vessel is constituted by a upper vessel main body having a lower opening and a lower lid for closing said lower opening,
and wherein said lower lid is used as a material locating part for placing said material to be processed, and said lower lid is designed such that it is movable in the vertical direction to insert and remove said material to be processed into and from said high-pressure vessel.

15. The high-pressure process apparatus according to claim 12, further comprising a lift unit disposed in a space between said first and second frame elements in said press position for moving up and down said lower lid.

16. The high-pressure process apparatus according to claim 12, wherein said first and second frame elements have a first contact part where they are contact with said high-pressure vessel at one end of the axis thereof and a second contact part they are contact with said high-pressure vessel at the other end of the axis thereof,
and wherein a space between said first and second contact parts is used as a convey passage for conveying said material to be processed when said material is inserted and removed into and from said high-pressure vessel.

17. The high-pressure process apparatus according to claim 12, wherein said high-pressure vessel and said press frame unit are disposed in a housing.

18. The high-pressure process apparatus according to claim 12, further comprising a maintenance opening disposed on the side of one of said first and second frame elements, where said one of said first and second frame elements is rotatable.
